(19) United States
(12) Patent Application Publication
(10) Pub. No.: US 2020/0285828 A1
(43) Pub. Date: Sep. 10, 2020

(54) METHOD AND SYSTEM FOR AUTOMATICALLY UPDATING AT LEAST ONE AIRPORT DATABASE

(71) Applicants: Airbus (S.A.S.), Blagnac (FR); Airbus Operations (S.A.S.), Toulouse (FR)

(72) Inventors: Jean-François Virepinte, Toulouse (FR); Benoît Couturier, Toulouse (FR); Fabien Moll, Toulouse (FR)

(21) Appl. No.: 16/807,949

(22) Filed: Mar. 3, 2020

(30) Foreign Application Priority Data
Mar. 8, 2019 (FR) 1902377

(51) Int. Cl. G06K 9/00; G06F 16/535; G06F 16/538; G08G 5/00; G06F 16/55

(52) U.S. Cl. CPC G06K 9/0063; G06F 16/535; G06F 16/55; G08G 5/0013; G06F 16/538

(57) ABSTRACT

A system for automatically updating an airport database relating to an airport includes an assembly of information sources installed on an aircraft for generating information and notably images of the airport when the aircraft is travelling over or above the airport, and units for processing this information and for correcting data from the airport database in the case where at least one difference is detected between the information generated and the data contained in the airport database, the system thus being capable of automatically updating the airport database each time that an aircraft able to generate and to collect information is taxiing over the airport and/or flying above the airport such that the data available in the airport database is recent and reliable.

### CROSS-REFERENCE TO RELATED APPLICATION

This application claims the benefit of and priority to French patent application 19 02377 filed on Mar. 8, 2019, the entire disclosure of which is incorporated by reference herein.

### TECHNICAL FIELD

The disclosure herein relates to a method and a system for automatically updating at least one airport database relating to an airport.

In the framework of the disclosure herein, an airport is understood to mean an assembly of installations intended for air traffic comprising a take-off and landing area for aircraft such as for example airplanes, notably transport planes, or helicopters. The term airport therefore encompasses a civilian or military airport, an aerodrome, a heliport, etc.

### BACKGROUND

Aircraft, notably transport planes, are generally equipped with one or more airport databases containing data and information on at least one airport that is intended to be used.

Such an airport database may, notably, comprise information (or data) on installations of the airport such as for example buildings, etc., namely notably their location and their size, information on runways including their location, their size, the end of runway and their slope, and/or information on taxiways, for example between a runway or a turn-off and an air terminal for boarding/disembarkation of passengers. Such an airport database may also comprise the state of verification of this data and its precision.

Such an airport database is carried on board the aircraft and is used by the pilot and by systems of the aircraft, for example monitoring, alert, piloting assistance systems, etc.

Of course, it is necessary to have reliable information available on board the aircraft, notably for reasons of safety and of performance of operations. For this purpose, it is necessary to update frequently and reliably each airport database used on the aircraft. It is also necessary to verify, during the preparation of the airport data, the validity and the precision of the information (for example based on a source other than aeronautical publications).

Usually, the current airport databases are updated notably using satellite information, human measurements and publications. Aeronautical publications of the AIP (for “Aeronautical Information Publication”) type are generally used. The AIP publications contain relevant information for the aircraft within a given airspace. However, pilots generally receive updates from the AIP publications once per month.

This usual solution has drawbacks, and in particular:
an insufficient airport coverage, certain airports not being covered;
difficulties (precision, obsolescence, cost) due to the complexity of the airspace and to the increase in the volume of published documents that are used;
a variable accuracy of the aeronautical publications used; and
above all, a long period of time between two successive updates of the airport database.

This usual situation, and notably the usual update, are not therefore completely satisfactory.

### SUMMARY

An aim of the disclosure herein is to overcome these drawbacks. For this purpose, it relates to a method for automatically updating at least one airport database relating to an airport.

According to the disclosure herein, the method comprises the following series of steps:

a step for generating information, implemented by an assembly of information sources installed in the aircraft, the step for generating information consisting in or comprising generating information on the airport when the aircraft is moving over or flying above the airport, the information comprising at least images of the airport generated by at least one camera belonging to the assembly of information sources;

a step for collecting information, implemented by a collection unit installed on the aircraft, consisting in or comprising collecting all of the information generated at the step for generating information;

a processing step, implemented by a processing unit, consisting in or comprising processing the information collected, including at least the images collected, for identifying one or more elements of the airport and for determining characteristics of the element or elements thus identified;

a comparison step, implemented by a comparison unit, consisting in or comprising comparing the element or elements identified together with the characteristics determined of the element or elements with data coming from the airport database in order to be able to detect, where relevant, one or more differences between, on the one hand, at least one of the elements identified or the characteristics and, on the other, data from the airport database; and

a correction step, implemented by a correction unit, consisting in or comprising correcting data from the airport database in the case where at least one difference is detected at the comparison step, the correction taking into account the difference, in order to update the airport database.

Thus, the disclosure herein allows the airport database to be automatically updated each time that an aircraft able to generate and collect information (and notably images) on the airport is taxiing over the airport and/or flying above the airport. Thus, the airport database may be updated frequently, which allows any recent changes to the airport to be taken into account. The airport database thus updated therefore has reliable data available.

The update may consist in or comprise updating elements added to or removed from the airport. In the framework of the disclosure herein, the term “element” means any element of infrastructure of the airport such as buildings, signalling or lighting, runway, taxiways, etc., together with other elements present on the airport, such as vegetation or construction equipment for example.

The update may also consist in or comprise updating the airport database when an element is still present but its characteristics have changed, such as the ground coverage or the height for a building or an object such as a crane for example. The changed characteristic may also relate to a runway (for landing/take-off), in particular when this characteristic is insufficiently precise in the database, or if this characteristic has been modified subsequent to works relating to the runway.

The update may also consist of or comprise the update of the magnetic orientation of the runway (for example in degrees) with respect to magnetic north, which moves from year to year.

The update may furthermore consist in or comprise updating the status of verification of the data from the airport database and their precision. The disclosure herein allows information to be collected enabling the database to be verified and thus the verification state to be changed.

In the framework of the disclosure herein, the airport database or databases correspond to at least one of the following databases: an airport database, a database of runways.

Furthermore, in one preferred embodiment, the processing step consists in or comprises determining at least one level of confidence associated with an element identified and with characteristics determined of the element identified, this level of confidence being used at least at the correction step for correcting or not correcting the airport database.

Furthermore, advantageously, the step for generating information consists in or comprises also generating information on geographical location, by localization sources carried on board the aircraft, and the processing step consists in or comprises using this localization information for identifying the element or elements.

Furthermore, advantageously, when the processing step identifies a runway of the airport as an element, it implements at least one estimation sub-step configured for estimating, as a characteristic, a slope of the runway of the airport.

Furthermore, advantageously, the method comprises a data transmission step, consisting in or comprising transmitting to user devices at least one of the following elements: the difference or differences detected at the comparison step, the airport database updated at the correction step.

The disclosure herein also relates to a system for automatically updating at least one airport database relating to an airport.

According to the disclosure herein, the system comprises:

an assembly of information sources installed on an aircraft and configured for generating information on the airport when the aircraft is travelling over or above the airport, the information comprising at least images of the airport generated by at least one camera belonging to the assembly of information sources;

a collection unit installed on the aircraft and configured for collecting all of the information generated by the assembly of information sources;

a processing unit configured for processing the information collected including at least the images collected in order to identify one or more elements of the airport and to determine characteristics of the element or elements thus identified;

a comparison unit configured for comparing the element or elements identified, together with the characteristics determined of the element or elements, with data coming from the airport database in order to be able to detect, where relevant, one or more differences between, on the one hand, at least one of the elements identified or the characteristics and, on the other, data from the airport database; and

a correction unit configured for correcting data from the airport database in the case where at least one difference is detected by the comparison unit, the correction taking into account the difference, in order to update the airport database.

Advantageously, the system comprises a data transmission unit configured for transmitting information generated by the system to user devices.

Furthermore, in one particular embodiment, the system also comprises a warning unit.

In a first embodiment, the processing unit, the comparison unit and the correction unit form, part of a central processing unit arranged in a ground station, and the system comprises a data transmission system configured for transmitting at least information generated by the collection unit installed on the aircraft to the central processing unit arranged in the ground station.

Furthermore, in a second embodiment, at least the processing unit and the comparison unit (and potentially the correction unit) are carried on board the aircraft.

### BRIEF DESCRIPTION OF THE DRAWINGS

The appended figures will allow it to be understood how the disclosure herein may be implemented. In these figures, identical references denote similar elements.

FIG. 1 shows schematically a first embodiment of a system for automatically updating an airport database.

FIG. 2 shows schematically a second embodiment of a system for automatically updating an airport database.

FIG. 3 is a side view of a transport airplane equipped with at least a part of an update system.

FIG. 4 is a top view of the transport airplane in FIG. 3, in which fields of view of devices for generating images installed on the aircraft have been highlighted and examples of generated images have been shown.

FIG. 5 is the block diagram of a method for automatically updating an airport database.

### DETAILED DESCRIPTION

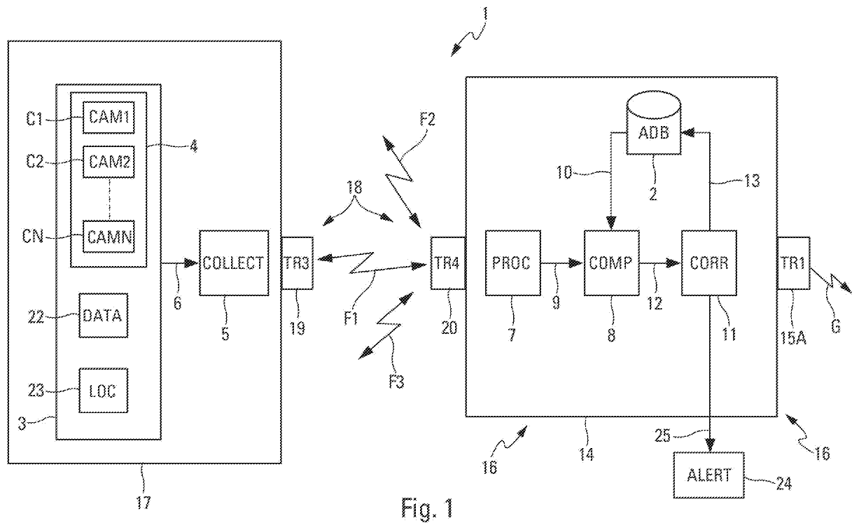

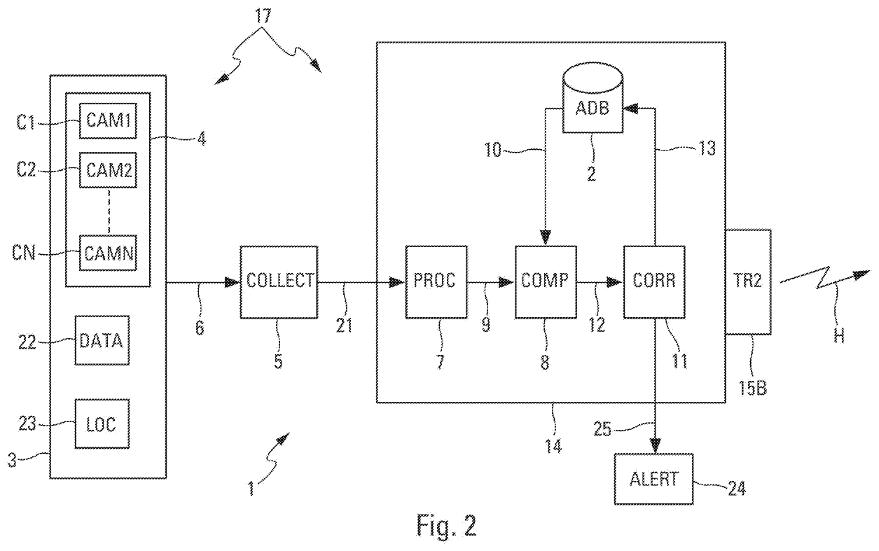

The system 1, shown schematically in two different embodiments, respectively in FIGS. 1 and 2, is designed to automatically update at least one airport database 2 relating to an airport. The term airport notably encompasses a civilian or military airport, an aerodrome, a heliport, etc.

Preferably, the airport database (or ADB) 2 corresponds to one of the following databases:

an airport mapping database which comprises information (or data) on permanent or temporary installations of the airport such as buildings, for example, or construction site elements (crane, etc.), this information notably comprising the location and the size, information on runways and/or information on taxiways, for example between a runway and a terminal building or a passenger departure and/or arrival area; and

a runway database which comprises information (or data) on runways of the airport, such as for example their location, their dimensions and their slope, together with information on the turn-offs.

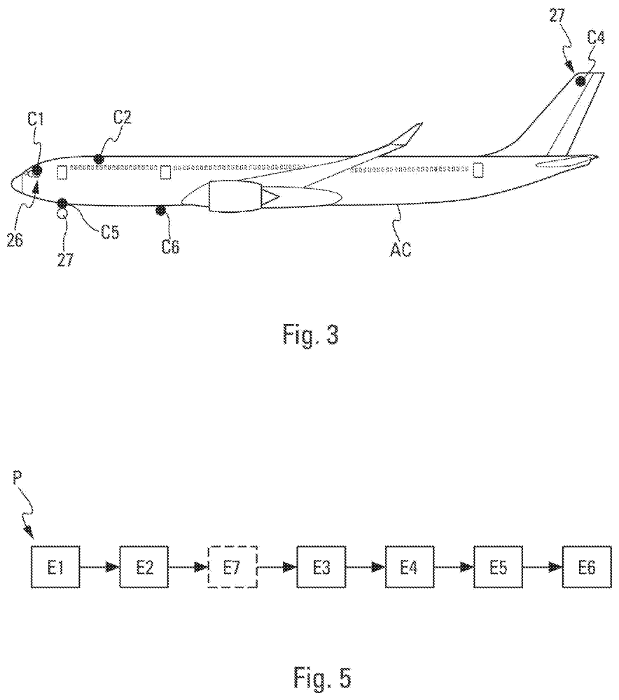

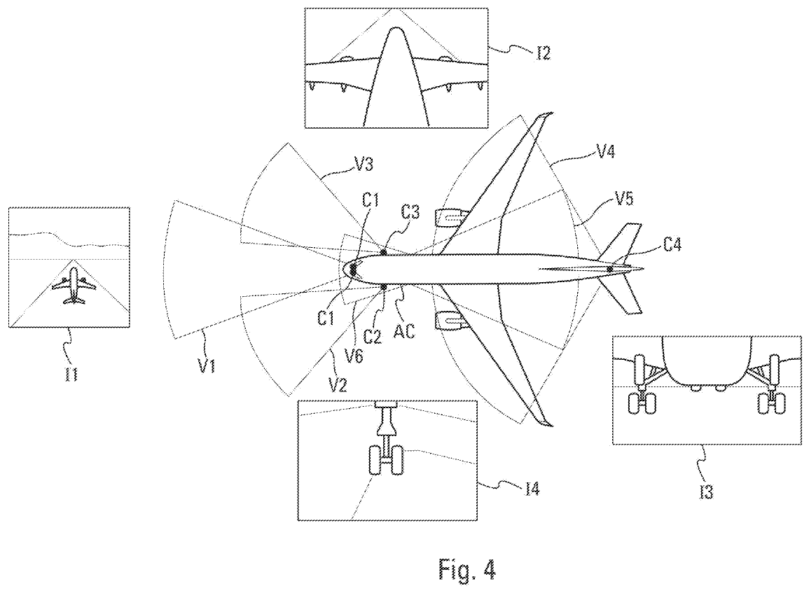

The automatic update system 1 comprises, as shown in FIGS. 1 and 2, an assembly 3 of information sources. This assembly 3 is installed on an aircraft such as the aircraft AC, in this case a transport airplane, shown in FIGS. 3 and 4. The assembly 3 is configured for generating information on the airport when the aircraft AC is travelling over or above the airport, in other words when it is taxiing over the airport and/or when it is flying above the airport. This assembly 3 comprises at least one, but preferably a plurality of information sources.

The assembly 3 notably comprises a set 4 of devices for generating images or cameras C1 to CN (CAM1 to CAMN), N being an integer with CAM (for “camera”). The term camera is understood to mean any device capable of generating images of the environment of the aircraft, whether these images be generated successively in the form of a video stream or in an isolated manner. This set 4 comprises at least one but preferably a plurality of cameras C1 to CN.

The system 1 also comprises a collection unit COLLECT (for “collection unit”) 5 installed on the aircraft and configured for collecting all of the information generated by the assembly 3 of information sources and notably by the set 4 of cameras C1 to CN. The information collected notably comprises images of the airport such as the images I1, I2, I3 and I4 (FIG. 4) generated by cameras. For this purpose, the collection unit 5 is connected via links, notably of the wired type, to the cameras C1 to CN. For reasons of simplification of the drawing, the links between the elements of the assembly 3 and the collection unit 5 are illustrated by a single link 6 in FIGS. 1 and 2.

The system 1 furthermore comprises:

a processing unit PROC 7 which is configured for processing the information collected by the collection unit 5 (included at least the collected images), which is received in the manner described hereinbelow. The processing unit 7 is configured for identifying one or more elements of the airport and for determining characteristics (height, surface, etc.) of the element or elements thus identified;

a comparison unit COMP 8 which is connected via a link 9 to the processing unit 7 and which is configured for comparing the element or elements identified, together with the characteristics determined of the element or elements, with data coming from the airport database 2. For this purpose, the comparison unit 8 has access to the data available in the airport database 2, as illustrated by a link 10 in FIGS. 1 and 2. The comparison unit 8 implements the aforementioned comparisons in order to be able to detect, where relevant, one or more differences between, on the one hand, at least one of the elements identified or its characteristics, and on the other, data from the airport database 2; and

a correction unit CORR 11, which is connected via a link 12 to the comparison unit 8 and which is configured for correcting (erroneous) data from the airport database 2 as illustrated by a link 13 in FIGS. 1 and 2. The correction unit 11 corrects the airport database 2 in the case where at least one difference is detected by the comparison unit 8. The correction implemented by the correction unit 11 takes into account the difference or differences detected in order to update the airport database 2.

In one preferred embodiment, the processing unit 7, the comparison unit 8 and the correction unit 11 form part of a central processing unit 14. The airport database 2 may be integrated into the central processing unit 14, as shown in FIGS. 1 and 2, or may be hosted in another system of the aircraft.

The system 1 also comprises a data transmission unit TR1, TR2 (with TR for “transmission unit”) 15A, 15B which is configured for transmitting to user devices (not shown) information generated by the system 1, and notably the updated airport database 2 or only the difference or differences detected by the comparison unit 8.

This or these differences represent a correction (or complement) to be applied to the database (by the correction unit 11) in order to update it. In this case, the correction unit 11 is situated in the user device, for example on the ground, and it updates the database based on this correction (or complement) received via the data transmission unit. This particular embodiment allows the volume of data transmitted by the data transmission unit to be reduced, facilitates its loading and avoids putting at risk the integrity of the uncorrected data from the airport database.

These user devices may be other aircraft in flight or on the ground which use the (updated) airport database 2. They may also be systems or devices situated on the ground, intended for example for air traffic control or for the management of the airport. The airport database 2 may also be used, for example, by a particular supplier for generating a database specific to aircraft, this specific database being subsequently installed in the aircraft. The database specific to an aircraft is a database extracted from the complete database, covering only the needs of this aircraft, with a view to facilitating its implementation and the loading of updates. The data transmission system of the aircraft is also configured for receiving information relating to corrections or complements of the database in the ground direction or from another airplane towards the aircraft. In the framework of the disclosure herein, the updating of the airport database comprises both the update of existing data and the potential addition of new information or data (representing a completion of the airport database).

In a first preferred embodiment, shown in FIG. 1, the central processing unit 14 comprising the processing unit 7, the comparison unit 8 and the correction unit 11 forms part of a system 16 established in a ground station.

In this first embodiment, the system 1 comprises a unit 17 comprising the assembly 3 and the collection unit 5, which is installed on board the aircraft.

The system 1 also comprises a data transmission system 18 which is configured for transmitting information from the aircraft to the unit 16 on the ground, and potentially also in the other direction from the unit 16 to the aircraft. The data transmission system 18 is configured for transmitting at least the information generated by the collection unit 5, which is used on the ground by the central processing unit 14 for updating the navigation database 2.

The data transmission system 18 comprises:

a unit (TR3) for transmission or for transmission/reception 19 of the usual type, which is installed on the aircraft AC; and

a unit (TR4) for transmission or for transmission/reception 20 of the usual type, which forms part of the system 16 on the ground.

The data transmission system 18 is such that the transmission/reception units 19 and 20 (which cooperate with each other) may transmit remote data between them, as illustrated by a double arrow F1 in FIG. 1.

In this first embodiment, the unit 16 also comprises the data transmission unit 15A which is configured for transmitting to user devices (not shown) information generated by the central processing unit 14, and notably the updated airport database 2 or a correction or complement (representing the differences detected by the comparison unit 8) to be applied, as illustrated by the arrow G. The updated airport database 2 or the correction or complement to be applied may notably be transmitted to the aircraft which plan to use the airport or the airports for which the airport database 2 comprises information.

Furthermore, in a second embodiment, shown in FIG. 2, the central processing unit 14 comprising the processing unit 7, the comparison unit 8 and the correction unit 11 forms part of the unit 17 and is installed on board the aircraft AC.

In this second embodiment, the collection unit 5 is simply connected via a link 21 to the processing unit 7.

In this second embodiment, the system 1 also comprises the data transmission unit 15B which is configured for transmitting to user devices (not shown) information generated by the central processing unit 14, and notably the updated airport database 2 or a correction (or complement), as illustrated by an arrow H in FIG. 2. In this second embodiment, the updated airport database 2 or the correction or complement to be applied to the airport database 2 may, notably, be transmitted to the ground station whose function is to manage the airport database 2 or the correction (or complement) and to communicate to the various aircraft users the airport database 2 or the correction (or complement) to be applied. It may also be envisaged for the updated airport database 2 or the correction (or complement) to be applied to be communicated from the aircraft AC directly to another aircraft.

Thus, irrespective of the embodiment in question, namely either the embodiment in FIG. 1, which is in part implemented on the ground, or the embodiment in FIG. 2, completely on board, the system 1 is capable of implementing the airport database 2 each time that the aircraft collects useful information, while taxiing over the airport and/or while flying above the airport.

By way of non-limiting illustration, irrespective of the embodiment of the system 1, the updated airport database 2 or the correction (or complement) to be applied to the airport database 2, may be transmitted to at least some of the following users:

an operational or maintenance center of an airline;

operators of the airport;

a supplier of airport databases or others;

aircraft.

In the preferred embodiment in FIG. 1, the unit 16 on the ground may receive information collected from a plurality of different aircraft each time that an aircraft equipped with the unit 17 collects information on the airport, while taxiing over the airport and/or while flying above the airport.

This plurality of generations and of collections of information is highlighted by various double arrows F1, F2 and F3 in FIG. 1, each of which illustrates a transmission of data received from a particular aircraft.

Thus, the airport database 2 may be updated frequently, which allows any recent changes in the airport to be taken into account. The airport database 2 thus frequently updated therefore disposes of reliable data.

The update may consist in or comprise updating elements (a building, a fixed object or mechanism such as a crane, etc.) added to or removed from the airport.

The update may also consist in or comprise updating particular characteristics when an element is still present, but its characteristics have changed, such as for example its ground coverage or its height for a building or a particular object. The characteristic which has changed may also be the slope of a runway which has been modified.

Moreover, the update performed by the system 1 is very fast, for example carried out in a few minutes after the collection of information, which is very short compared to the current update time which is of the order of one month. One choice of implementation might be to apply or to send the update when the aircraft is parked or when it is back at its base.

Moreover, the update carried out by the system 1 may be applied to any type of airport.

In the framework of the disclosure herein, the collection of information may be carried out using any type of aircraft, such as an airplane, a helicopter, etc.

The collection of information, with a view to the update, may notably be implemented in the following phases of an aircraft:

parking;

taxiing;

approach and landing;

over-flight before landing;

alignment before take-off;

take-off;

flight above the airport.

The various elements of the system 1 are hereinafter described in more detail.

With regard to the set 4, fields of view V1 to V5 of various cameras together with images I1 to I4 able to be taken by some of these cameras are shown schematically, by way of illustration, in FIG. 4.

By way of non-limiting illustration, the set 4 may comprise, as shown in FIGS. 3 and 4:

one or more cameras C1 installed in the cockpit 26 of the aircraft AC, for example of the visible or polarized type, which take images towards the front (of the aircraft) according to a field of view V1 and generate images such as the image I1;

one or more cameras C2 and C3 installed on either side of the fuselage towards the front of the aircraft AC, for example in the windows of the aircraft AC, in particular of the visible type, which take images towards the front according to fields of view V2 and V3;

one or more cameras C4 installed on top of the tail-fin 27 of the aircraft AC which take images towards the front according to a field of view V4 and generate images such as the image I2;

one or more cameras C5 installed under the aircraft AC towards the front of the aircraft AC, for example of the infrared type, which take images towards the rear according to a field of view V5 and generate images such as the image I3; and

one or more cameras C6 installed under the aircraft AC towards the front of the aircraft AC, which take images towards the front according to a field of view V6 and generate images such as the image I4.

Some of these cameras may correspond to cameras already present on the aircraft and others may be cameras installed specifically for the implementation of the disclosure herein.

Preferably, the camera or cameras C1 to C6 used have sufficient capacities for measuring characteristics in a precise manner.

However, an insufficient quality may be compensated by the generation of a plurality of images of the same region by cameras located at various locations on the aircraft and/or by the generation of a plurality of images during a plurality of successive flights.

By way of illustration, at least some of the cameras C1 to CN use the following technologies:

a high-resolution negative color aerial film in order to obtain aerial images. The system must be sensitive to the colors yellow, green, orange and to the red hues (for the leaves of trees notably) and record them on the film;

a photogrammetry scanner, photogrammetry corresponding to the determination of the dimensions of the objects by measurements made on photographic perspectives of these objects. An aerial film is converted into a matrix image on a photogrammetry scanner with a high geometrical resolution, allowing sizes of scanned pixels of 15 micrometers or less to be produced;

infrared cameras which record the various types of infrared radiation emitted by the objects, which vary as a function of their temperature. It is then possible to distinguish various surfaces (for example an asphalt runway is identified with an infrared radiation different from that of the grass verge of the runway);

large-format and high-quality digital cameras. The sensor must be geometrically stable and have a system calibrated for a superposition of high-precision photogrammetry.

In one particular embodiment, as shown in FIGS. 1 and 2, the assembly 3 also comprises:

one or more auxiliary data generation sources DATA 22, such as a lidar 27 (FIG. 3) which is for example installed under the aircraft AC towards the front and which observes towards the front, and/or a weather radar and/or a mm-wave radar. The auxiliary data generation sources 22 may also comprise the usual equipment on the aircraft capable of supplying the current values of parameters of the aircraft, such as for example the heading, the angle of attack, the speed, the height with respect to the ground, etc.; and

one or more usual localization units LOC 23, in particular a unit forming part of a geolocation system, notably of the GPS (for “Global Positioning System”) type.

The localization unit or the units 23 are designed to generate information on geographical location, for example the position of a camera at the time when it takes an image such as the images I1 to I4. The processing unit 7 uses this location information for identifying one or more elements. The localization may be implemented also using, for example, a runway database, a map of the airport and/or a satellite map.

Furthermore, in order to determine the position of an element, the processing unit 7 may implement a localization using the principle of stereovision. The position of the element is calculated by triangulation based on the coordinates of its imaged representation in two different images, taking into account the known position of the cameras at the times when the two images are taken. This may be two cameras situated at different positions on the aircraft, which each take an image at the same time, or else one and the same camera that takes images at two different times as the aircraft is travelling.

Furthermore, in one particular embodiment, the system 1 also comprises a warning unit 24 which is for example connected to the correction unit 11 via a link 25, as shown in FIGS. 1 and 2.

The warning unit 24 is configured for generating an alert when the correction unit 11 has detected a significant difference between the information collected and the current data from the airport database 2. This may notably be related to differences which could have an impact on safety, such as a shortening of a runway for example. The alert generated by the warning unit 24 may notably be transmitted to user devices, via the data transmission unit 15A, 15B.

The alert may notably be transmitted to aircraft located at the airport or near to the airport, in particular an aircraft in approach. In this case, additional procedures adapted to the situation may be provided, for example where the pilot of the aircraft receiving the alert (from another aircraft, for example) requests confirmation from air traffic control of the difference detected.

In one particular embodiment, in order to process the information and notably the images collected by the collection unit 5, in order to be able to recognize and identify elements and also to be able to determine characteristics (size, etc.), the processing unit 7 implements image recognition processing operations. These may notably be image recognition processing operations based on one of the following methods:

a machine learning method, in other words a method using a learning mode by which the processing unit 7 acquires knowledge and new capabilities and improves its efficiency by basing this on results obtained during previous processing operations; and

a usual image processing method.

Using image recognition processing, it is possible to detect, on the images generated by the assembly 3, at least some of the following characteristics:

colors;

shapes;

figures and letters;

signs;

objects.

Furthermore, in one particular embodiment, the processing unit 7 also determines a level of confidence associated with an element identified and with characteristics determined of the element identified. This level of confidence is used by the correction unit 11 in order to decide whether to use or not to use the information associated with this level of confidence, in order to correct the airport database 2. Thus, by way of illustration, it may be envisaged that, if the level of confidence associated with a new piece of information (for example the presence or otherwise of an element or else modified characteristics of an element) which is different from that recorded in the airport database 2, is less than or equal to a predetermined threshold, the processing unit 7 does not take the new information into account and conserves the information present in the airport database 2.

On the other hand, when the level of confidence is greater than the predetermined threshold, the processing unit 7 does take the new information into account and corrects the airport database 2 accordingly.

By way of illustration, the level of confidence may be reduced if the element in question is small, far away, or displayed under degraded conditions (rain, dark, etc.).

In one particular embodiment, when the processing unit 7 identifies, as the element, a runway of the airport, it implements at least one estimation for estimating, as the characteristic, a slope of this runway of the airport.

For this purpose, the processing unit 7 may implement a first estimation or calculation mode, according to which it calculates the slope based on a measurement of the difference in height of the runway between two longitudinal positions on the runway. These two longitudinal positions are separated by a known, preferably predetermined, distance, for example of 100 meters.

The processing unit 7 may also implement a second estimation or calculation mode, according to which it calculates the slope based on the load on the landing gear and on a pitching moment of the aircraft.

It may also be provided for the successive aircraft to collect information on the current state of a runway, which allows a consolidated, complete and up-to-date awareness of this state.

A method P for automatically updating an airport database 2 relating to an airport is hereinafter described, which method is implemented by a system 1 such as that described hereinabove.

This method P comprises, as shown in FIG. 5, the following series of steps:

a step for generating information E1, implemented by the ensemble 3 of information sources installed on the aircraft AC. This step for generating information E1 consists in or comprises generating information (comprising at least images) relating to the airport when the aircraft equipped with the assembly 3 is travelling over or above the airport;

a step for collecting information E2, implemented by the collection unit 5 installed on the aircraft, consisting in or comprising collecting all of the information generated at the step for generating information E1 by the assembly 3;

a processing step E3, implemented by the processing unit 7, consisting in or comprising processing the information collected (including at least the images collected) for identifying one or more elements of the airport and for determining characteristics of the element or elements thus identified;

a comparison step E4, implemented by the comparison unit 8, consisting in or comprising comparing the element or elements identified (at the processing step E3), together with the characteristics determined (at the processing step E3) of the element or elements, with data coming from the airport database 2 in order to be able to detect, where relevant, one or more differences between, on the one hand, at least one of the elements or characteristics identified and, on the other, data from the airport database 2; and

a correction step E5, implemented by the correction unit 11, consisting in or comprising correcting data from the airport database 2 in the case where a difference is detected at the comparison step, the correction taking into account the difference detected. This correction step E5 enables the airport database 2 to be updated.

The method P also comprises a data transmission step E6, implemented by the data transmission unit 15A, 15B, consisting in or comprising transmitting at least the airport database 2, updated at the correction step E5, to user devices (not shown).

When the method P is implemented by the second embodiment of the system 1, shown in FIG. 2, the information collected at the step for collecting information E2 by the collection unit 5 installed on board the aircraft is directly transmitted to the processing unit 7, which is also carried on board, for it to carry out the processing operations provided. The steps for comparison E4, for correction E5 and for transmission of data E6 are also implemented on the aircraft.

In contrast, when the method P is implemented by the first embodiment of the system 1, shown in FIG. 1, the information collected at the information collection step E2 on the aircraft AC is transmitted, during an additional step, namely a data transmission step E7 (shown by the dashed line in FIG. 5), from the aircraft AC to the unit 16 on the ground, which comprises the processing unit 7 designed to carry out the processing operations provided. The steps for comparison E4, for correction E5 and for transmission of data E6 are also implemented on the ground.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatically updating at least one airport database relating to an airport, the method comprising a series of steps of:
generating information, implemented by an assembly of information sources installed on an aircraft, the step for generating information comprising generating information on the airport when the aircraft is travelling over or above the airport, the information comprising at least images of the airport generated by at least one camera forming a part of the assembly of information sources;
collecting information, implemented by a collection unit installed on the aircraft, comprising collecting all of the information generated at the step for generating information;
a processing step, implemented by a processing unit, comprising processing the information collected including at least the images collected for identifying one or more elements of the airport and for determining characteristics of the element or elements thus identified;
a comparison step, implemented by a comparison unit, comprising comparing the element or elements identified, together with the characteristics determined of the element or elements, with data coming from the airport database in order to be able to detect, where relevant, one or more differences between, on the one hand, at least one of the elements identified or the characteristics and, on the other, data from the airport database; and
a correction step, implemented by a correction unit, comprising correcting data from the airport database in the case where a difference is detected at the comparison step, the correction taking into account the difference, in order to update the airport database,
the processing step comprising determining at least one level of confidence associated with an element identified and with characteristics determined of the element identified, this level of confidence being used at least at the correction step for correcting or not correcting the airport database.

2. The method of claim 1, wherein generating information comprises also generating information on geographical location, by localization sources carried on board the aircraft, and wherein the processing step comprises using the localization information for identifying the element or elements.

3. The method of claim 1, wherein, when the processing step identifies a runway of the airport as an element, it implements at least one estimation sub-step configured for estimating, as a characteristic, a slope of the runway of the airport.

4. The method of claim 1, comprising a data transmission step comprising transmitting to user devices at least one of elements selected from the group consisting of: a difference or differences detected at the comparison step, and airport database updated at the correction step.

5. A system for automatically updating at least one airport database relating to an airport, the system comprising:
an assembly of information sources installed on an aircraft and configured for generating information on the airport when the aircraft is travelling over or above the airport, the information comprising at least images of the airport generated by at least one camera belonging to the assembly of information sources;
a collection unit installed on the aircraft and configured for collecting all of the information generated by the assembly of information sources;
a processing unit configured for processing the information collected including at least the images collected in order to identify one or more elements of the airport and to determine characteristics of the element or elements thus identified;
a comparison unit configured for comparing the element or elements identified, together with the characteristics determined of the element or elements, with data coming from the airport database in order to be able to detect, where relevant, one or more differences between at least one of the elements identified or the characteristics, and data from the airport database; and
a correction unit configured for correcting data from the airport database in the case where at least one difference is detected by the comparison unit, the correction taking into account the difference, in order to update the airport database,
the processing unit being configured for determining at least one level of confidence associated with an element identified and with characteristics determined of the element identified, the correction unit configured to use the level of confidence for correcting or not correcting the airport database.

6. The system of claim 5, comprising a data transmission unit configured for transmitting information generated by the system to user devices.

7. The system of claim 5, comprising a warning unit.

8. The system of claim 5, wherein the processing unit, the comparison unit and the correction unit form part of a central processing unit arranged in a ground station, and wherein the system comprises a data transmission system configured for transmitting at least information generated by the collection unit installed on the aircraft to the central processing unit arranged in the ground station.

9. The system of claim 5, wherein at least the processing unit and the comparison unit are carried on board the aircraft.
